(19) United States
(12) Patent Application Publication
(10) Pub. No.: US 2012/0223038 A1
(43) Pub. Date: Sep. 6, 2012

(54) U-SHAPED SHELF

(75) Inventor: Brent Bean, Austin, TX (US)

(73) Assignee: Brent Bean, Austin, TX (US)

(21) Appl. No.: 13/040,723

(22) Filed: Mar. 4, 2011

(51) Int. Cl. A47B 96/02; B23P 17/00; B23P 11/00

(52) U.S. Cl. 211/90.01; 29/428; 29/527.1

(57) ABSTRACT

A shelf includes a U-shaped member configured to be installed in a cabinet having a back wall and opposing side walls. The width of the U-shaped member is the width of the back wall of the cabinet. The U-shaped member rests upon support pins inserted into openings within opposing side walls of a cabinet; alternatively, the U-shaped member rests upon support legs vertically inserted into openings disposed in the underside of the U-shaped member. The U-shaped member comprises a single piece; alternatively, the U-shaped member comprises a first piece connected to a second piece to adjust the U-shaped member width to the cabinet width prior to installation. The first and second pieces may include a sliding dove tail track mechanism, or the first piece may slide within the second piece, or they may have ridges and grooves for snapping the two pieces together.

### FIELD OF THE INVENTION

The present invention relates in general to the field of cabinet shelving, and more particularly, to a cabinet shelf ideal for small containers.

### BACKGROUND OF THE INVENTION

There are many problems and requirements that exist when storing small containers, such as spice containers. These problems include, but are not limited to the following. The storage design should not take up valuable countertop space, but should make efficient use of unused space within a cabinet. The storage design should make storage containers readily visible to the user. The storage design should make storage containers easily accessible to the user. The storage design should be easy to install within a cabinet. The storage design should, if possible, use existing apparatus for shelving installation and support. The storage design should not preclude items currently stored in the cabinet from being stored in the cabinet after installation of the storage design. When storing spices, the storage design should provide a dark storage location since some spices degrade with light. The storage design should be inexpensive and should be simple and easy to manufacture.

Several conventional designs for a small container storage system have been provided. For example, U.S. Pat. No. 2,643,931 issued Jun. 23, 1953 discloses a V-shaped shelf with the objective of making visible the small containers which are placed on the V-shaped shelf. The V-shaped shelf is fastened to the flat underside surface of a shelf or cabinet ceiling member above it. Because the V-shaped shelf is intended to be fastened to the flat underside surface of a shelf or cabinet ceiling member above it, the height of containers to be placed on the V-shaped shelf is limited. The V-shaped shelf may prevent preexisting items stored in the cabinet from being stored in the cabinet after the V-shaped shelf is installed since it takes up space in the center of the cabinet. Placing taller items behind the V-Shaped shelf after installation would likely make access to them difficult. Finally, the V-shaped shelf employs sides with flanges used to fasten the shelf to the shelf or ceiling above it. Additionally, U.S. Pat. No. 2,472,004 issued May 31, 1949 discloses an L-shaped shelf secured to wall surfaces using adhesive strips.

However, there exists the need for a container storage design that attempts to solve a larger number of the problems described above.

### BRIEF SUMMARY OF INVENTION

In one aspect the present invention provides a shelf. The shelf includes a U-shaped member configured to be installed in a cabinet having a back wall and opposing side walls. The width of the U-shaped member is the width of the back wall of the cabinet. The U-shaped member is configured to rest upon support pins inserted into openings within the opposing side walls that lie on a horizontal plane. Or, the U-shaped member is configured to rest upon support legs vertically inserted into openings disposed in the underside of the U-shaped member. In one embodiment, the support legs comprise at least two support legs on each side of the U-shaped member near the opposing side walls. In one embodiment, the shelf comprises a single member constructed to a predetermined cabinet width. In another embodiment, the U-shaped member comprises a first piece configured to connect to a second piece to enable the width of the U-shaped member to be adjusted to the width of the cabinet prior to installation therein. In one embodiment, the first piece slides horizontally within the second piece. In another embodiment, the first and second pieces may include a dove tail track mechanism by which the first piece slides horizontally within the second piece. In another embodiment, the U-shaped member comprises a third piece configured to be placed over an exposed portion of the first piece to cause the entire surface of the U-shaped member to be the same height. The third piece may be placed over an exposed portion of the first piece to cause the entire surface of the U-shaped member to be the same height, wherein the third piece includes non-dove tail track protrusions on its bottom to enable it to sit into dove tail track openings of a top of the first piece. In another embodiment, the first and second pieces may include grooves and ridges on opposing sides by which the first and second pieces snap together. The U-shaped member may be constructed by an injection molded plastic manufacturing process.

In another aspect, the present invention provides a method for manufacturing a shelf. The method includes constructing a U-shaped member configured to be installed in a cabinet having a back wall and opposing side walls. The width of the U-shaped member is the width of the back wall of the cabinet.

An advantage of the U-shaped shelf is that it allows easy access and visibility to frequently used items, especially small items such as spice containers. Furthermore, the U-shaped shelf makes efficient use of unused space within a cabinet and is easy to install. The U-shaped shelf also provides flexibility to use various options of installation, including an existing shelf support installation apparatus, such as pins inserted into the side walls. Additionally, the U-shaped shelf may be installed in one of multiple vertical positions relative to the shelf positioned above or below it. Still further, the U-shaped shelf does not require adhesive strips or flanges to fasten it to a ceiling or shelf above. Finally, the simplicity of the U-shaped shelf may make it less expensive to manufacture than conventional designs.

### BRIEF DESCRIPTION OF THE DRAWINGS

FIG. 1 is an isometric view of a U-shaped shelf installed inside a cabinet according to the present invention.

FIG. 2 is a top down view of the U-shaped shelf of FIG. 1.

FIGS. 3A and 3B are cross sectional views of a cabinet side wall vertically taken at the middle of an opening according to the present invention.

FIG. 4 is an adjustable-width U-shaped shelf according to the present invention.

FIG. 5 is a detailed section view of the adjustable-width U-shaped shelf of FIG. 4.

FIG. 6 is a cross section view of the adjustable-width U-shaped shelf of FIG. 4.

FIG. 7 is an illustration of an adjustable-width U-shaped shelf according to an alternate embodiment of the present invention.

FIG. 8 is a detailed section view of the adjustable-width U-shaped shelf of FIG. 7.

FIG. 9 is a cross section view of the adjustable-width U-shaped shelf of FIG. 7.

FIG. 10 is a U-shaped shelf with leg supports according to an alternate embodiment of the present invention.

FIG. 11 is an illustration of an opening manufactured in the underside of a U-shaped shelf according to the present invention.

FIG. 12 is an illustration of the U-shaped shelf of FIG. 10 installed in a cabinet utilizing support legs attached to the underside of the U-shaped shelf to provide the desired vertical height within the cabinet according to the present invention.

FIGS. 13 and 14 are illustrations of an adjustable-width U-shaped shelf according to an alternate embodiment of the present invention.

FIG. 15 is a cross section view of the adjustable-width U-shaped shelf of FIG. 13.

### DETAILED DESCRIPTION OF THE INVENTION

Embodiments are described herein of a U-shaped shelf designed to fit within a cabinet. The shelf has outer dimensions (width and depth) equal to other shelves sized for the cabinet. Preferably, the shelf is designed to be installed like other shelves designed to fit within the cabinet. The U-shape may allow a larger number of containers to be stored and allow the containers to be more visible. The U-shaped shelf installs around the inside perimeter of the cabinet space, thus leaving the interior space of the cabinet available for preexisting items and efficiently utilizing existing space.

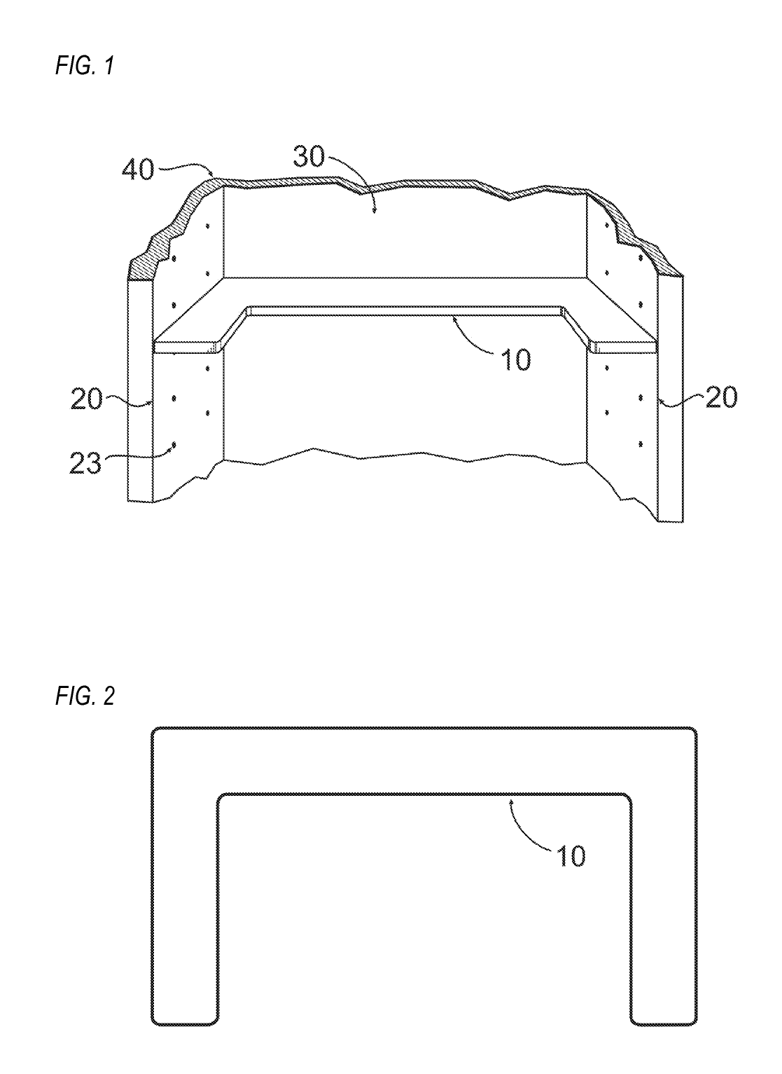

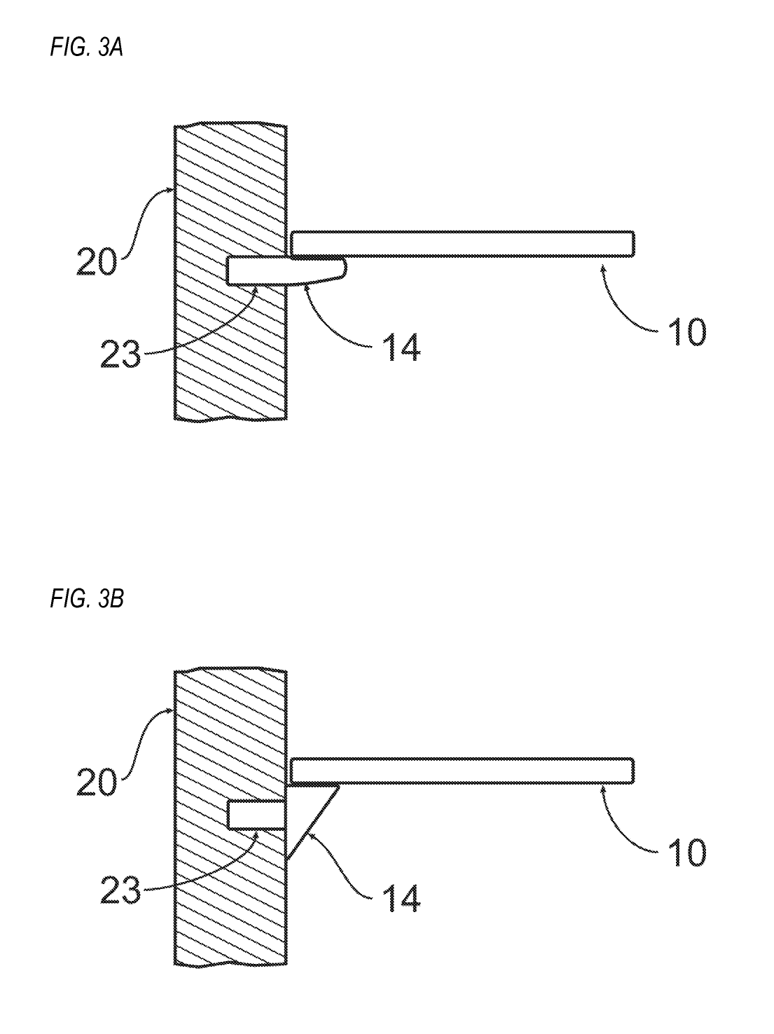

Referring now to FIG. 1, a U-shaped shelf 10 as it is installed inside a cabinet 40 with side walls 20 and a back wall 30 according to the present invention is shown. U-shaped shelf 10 is shown installed utilizing an existing shelving support system manufactured within the cabinet 40. The shelving support system comprises openings 23, or holes, drilled in the side walls 20 of the cabinet 40. A pair of shelf support pins 14 (see FIG. 3) are installed in and extend out of two or more openings 23 in each cabinet side wall 20. Many cabinets already exist with holes or openings drilled in the side walls of the cabinet to support currently existing full-size shelves, such that shelf support pins 14 may be inserted for supporting the U-shaped shelf 10. Thus, advantageously, the U-shaped shelf may be easily installed and utilize an existing shelf support system.

Referring now to FIG. 2, a top view of the U-shaped shelf 10 according to the present invention is shown. The flat surface of the U-shaped shelf 10 provides an area to support, for example, spice containers, salt and pepper shakers, and other containers. Multiple U-shaped shelves 10 may be installed within a cabinet to provide additional storage area.

Referring now to FIG. 3A, a cross section of a cabinet 40 side wall 20 vertically taken at the middle of opening 23 according to the present invention is shown. As shown, support pin 14 is installed in opening 23, and supports U-shaped shelf 10. FIG. 3B shows the same view of a cross section of cabinet 40 side wall 20 but contains an alternative style support pin 14.

In one embodiment, the U-shaped shelf 10 is manufactured by injection molded plastic manufacturing procedures, which would satisfy the requirements for a durable, sturdy and inexpensive product. However, the U-shaped shelf 10 may be constructed from other materials, such as wood, and by other manufacturing procedures.

To install the U-shaped shelf 10, a user may insert four shelf support pins 14 into four existing openings in the side walls 20 of the cabinet 40 all on the same horizontal plane. The user may then simply rest the U-shaped shelf 10 on the installed shelf support pins 14.

In one embodiment, the U-shaped shelf 10 comprises a single solid member, as shown in FIG. 2, manufactured to fit a cabinet 40 of a particular width. In another embodiment, the U-shaped shelf 10 comprises two or more members that when fitted together create an adjustable U-shaped shelf.

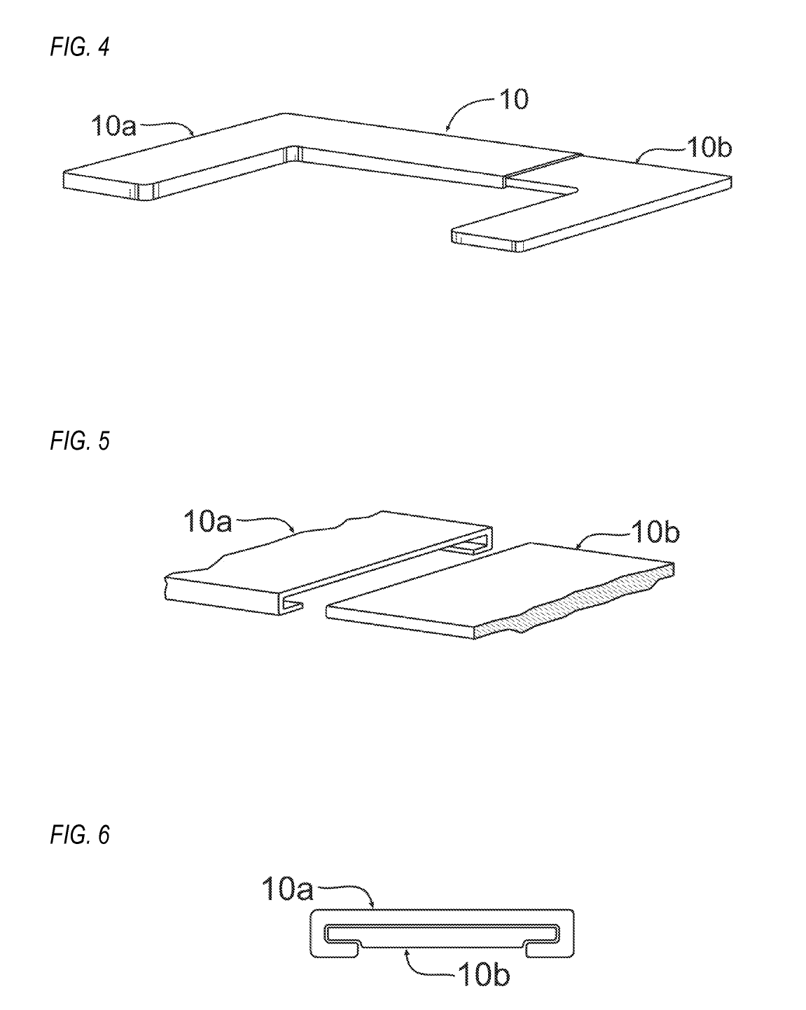

Referring now to FIG. 4, an adjustable-width U-shaped shelf 10 according to the present invention is shown. The U-shaped shelf of FIG. 4 comprises two oppositely disposed L-shaped pieces denoted first piece 10a and second piece 10b. The first piece 10a has a hollow leg, namely the leg that abuts the back wall 30 of the cabinet 40, with an opening into the hollow leg, as shown in more detail in the section view of FIG. 5. The leg of the second piece 10b that abuts the back wall 30 of the cabinet 40 is slightly smaller than the opening into the hollow leg of first piece 10a, as shown in more detail in the section view of FIG. 5. Consequently, second piece 10b may be inserted into first piece 10a to assemble the U-shaped shelf 10, as shown in FIG. 4 and in the cross-section view of FIG. 6. The assembled U-shaped shelf 10 may be thus adjusted to the width of the cabinet 40 to fit a plurality of different cabinet widths and yet maintain the ridged characteristics required for the shelf.

An advantage of the adjustable U-shaped shelf embodiment is that it allows flexibility to reduce costs, including manufacturing costs and costs associated with sale of the product such as display space in retail stores.

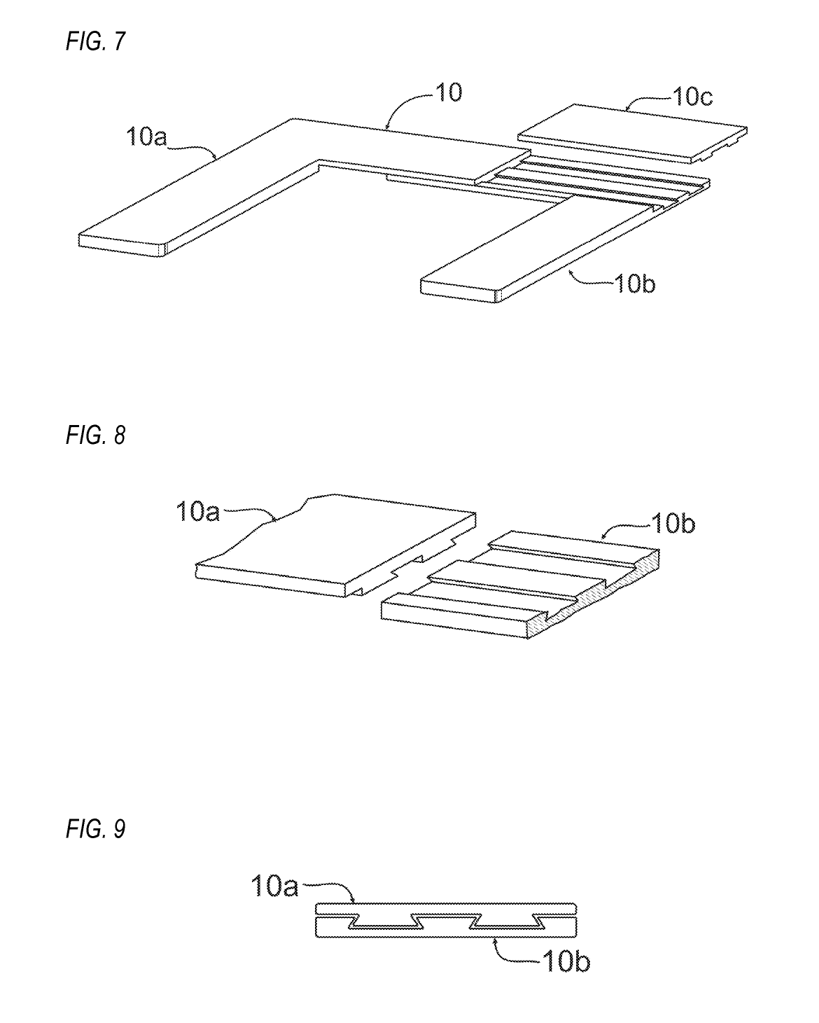

Referring now to FIG. 7, an adjustable-width U-shaped shelf 10 according to an alternate embodiment of the present invention is shown. The U-shaped shelf of FIG. 7 is similar in some respects to the adjustable-width U-shaped shelf 10 of FIG. 4. That is, the U-shaped shelf of FIG. 7 includes a first L-shaped piece 10a and a second L-shaped piece 10b opposing first piece 10a. However, the embodiment of FIG. 7 comprises a third piece, denoted 10c. Furthermore, the legs of the first piece 10a and second piece 10b that abut the back wall 30 fit together using a dove tail track mechanism, as shown in the section view of FIG. 8. FIG. 9 shows a cross section of the dove tail track mechanism with the first piece 10a and the second piece 10b assembled together to form the ridged adjustable U-shaped shelf 10. The third piece 10c is placed over an exposed portion of the second piece 10b, which allows the entire top surface of the U-shaped shelf 10 to be the same height. As shown in FIG. 7, the third piece 10c does not have a dove tail track bottom which allows it to simply sit in the dove tail track openings of the second piece 10b. In one embodiment, the third piece 10c may be cut to the length of the exposed portion of the second piece 10b once the first and second pieces 10a/10b have been adjusted to the width of the cabinet 40. In another embodiment, the third piece 10c is manufactured with scores to enable the user to break the third piece 10c to the appropriate length.

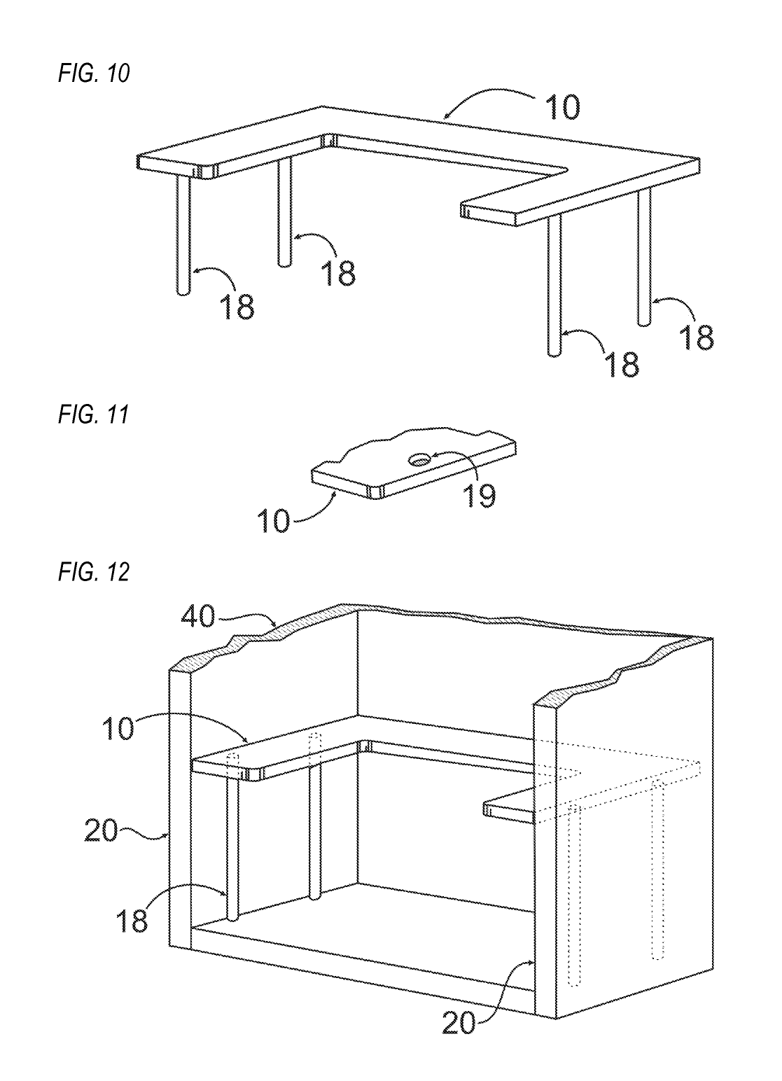

Referring now to FIG. 10, a U-shaped shelf 10 with leg supports 18 according to an alternate embodiment of the present invention is shown. The U-shaped shelf 10 embodiment of FIG. 10 may be installed in a cabinet not fitted with openings 23 of FIG. 1. Additionally, the leg supports 18 of FIG. 10 may be employed to raise up the U-shaped shelf 10 to a desired height. As shown in FIG. 10, the U-shaped shelf can be supported using legs 18 attached to the underside of the U-shaped shelf 10. The legs 18 may be attached to the underside of the U-shaped shelf 10 using various methods. One method comprises manufacturing the underside of the U-shaped shelf 10 to contain openings into which the support legs 18 may be inserted and fixed in place. FIG. 11 illustrates an example of an opening 19 manufactured in the underside of the U-shaped shelf 10. FIG. 12 shows the U-shaped shelf 10 of FIG. 10 installed in a cabinet 40 utilizing support legs 18 attached to the underside of a U-shaped shelf 10 to provide the desired vertical height within the cabinet 40. As shown in FIG. 12, preferably the support legs 18 are attached near the outer edge of the U-shaped shelf 10, i.e., in close proximity to the side walls 20 of the cabinet 40, which makes the legs 18 practically unobtrusive to space utilization below the U-shaped shelf 10.

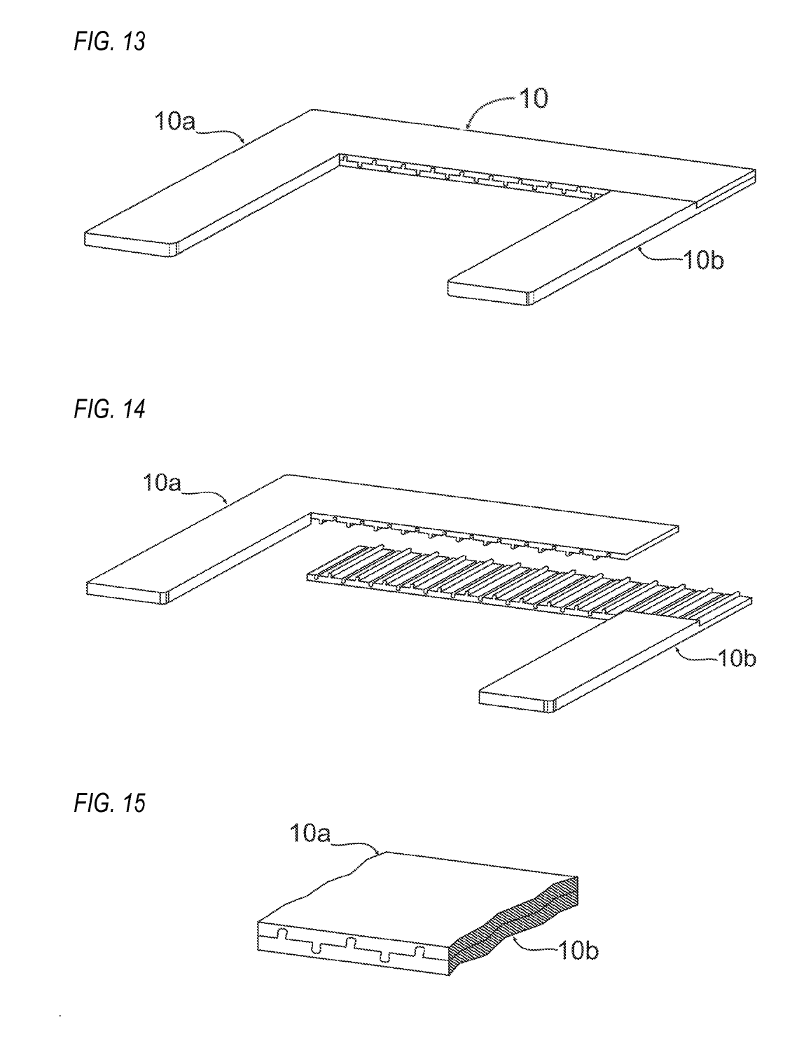

Referring now to FIG. 13, an adjustable-width U-shaped shelf 10 according to an alternate embodiment of the present invention is shown. The U-shaped shelf 10 of FIG. 13 comprises two identical L-shaped pieces 10a and 10b, shown apart in FIG. 14, that when secured together form a rigid U-shaped shelf 10 as shown in FIG. 13. The L-shaped pieces 10a and 10b are configured with ridges and grooves such that the ridges and grooves of the first L-shaped member 10a line up with the grooves and ridges of the second L-shaped member 10b when it is flipped over, as shown. The ridges of one L-shaped member 10a are configured to snap into the grooves of the opposing L-shaped member 10b and vice versa. The assembled U-shaped shelf 10 may be thus adjusted to the width of the cabinet 40 to fit a plurality of different cabinet widths and yet maintain the ridged characteristics required for the shelf FIG. 15 shows a cross section of the ridge and groove mechanism with the first piece 10a and the second piece 10b assembled together to form the ridged adjustable U-shaped shelf 10. In one embodiment, the two pieces 10a and 10b may be cut or broken to the width of the cabinet 40.

An advantage of the adjustable U-shaped shelf embodiment of FIG. 13 is that only one L-shaped member design is required, which reduces manufacturing costs. Another advantage is it provides a flat top U-shaped surface once two identical L-shaped members are fastened together. Yet another advantage is it forms a rigid U-shaped shelf where the two L-shaped members have no potential to slide apart.

While various embodiments of the present invention have been described herein, it should be understood that they have been presented by way of example, and not limitation. It will be apparent to persons skilled in the relevant art that various changes in form and detail can be made therein without departing from the scope of the invention. Thus, the present invention should not be limited by any of the exemplary embodiments described herein, but should be defined only in accordance with the following claims and their equivalents. Finally, those skilled in the art should appreciate that they can readily use the disclosed conception and specific embodiments as a basis for designing or modifying other structures for carrying out the same purposes of the present invention without departing from the scope of the invention as defined by the appended claims.

I claim:

1. A shelf, comprising:
a U-shaped member, configured to be installed in a cabinet having a back wall and opposing side walls;
wherein the width of the U-shaped member is the width of the back wall of the cabinet.

2. The shelf of claim 1, wherein the U-shaped member is configured to rest upon support pins inserted into openings within the opposing side walls, wherein the openings lie on a horizontal plane.

3. The shelf of claim 2, wherein the support pins comprise at least two support pins in each of the opposing side walls.

4. The shelf of claim 1, wherein the U-shaped member is configured to rest upon support legs vertically inserted into openings disposed in the underside of the U-shaped member.

5. The shelf of claim 4, wherein the support legs comprise at least two support legs on each side of the U-shaped member near the opposing side walls.

6. The shelf of claim 4, wherein the openings disposed in the underside of the U-shaped member are located in close proximity to the opposing side walls.

7. The shelf of claim 1, wherein the U-shaped member comprises a single member constructed to a predetermined cabinet width.

8. The shelf of claim 1, wherein the U-shaped member comprises a first L-shaped piece connected to a second L-shaped piece to enable the width of the U-shaped member to be adjusted to the width of the cabinet prior to installation therein.

9. The shelf of claim 8, wherein the first piece is configured to slide horizontally within the second piece to enable the width of the U-shaped member to be adjusted to the width of the cabinet prior to installation therein.

10. The shelf of claim 8, wherein opposing surfaces of the first and second pieces include a dove tail track mechanism to enable the first and second pieces to slide horizontally relative to one another to enable the width of the U-shaped member to be adjusted to the width of the cabinet prior to installation therein.

11. The shelf of claim 10, wherein the U-shaped member further comprises a third piece configured to be placed over an exposed portion of the first piece to cause the entire surface of the U-shaped member to be the same height.

12. The shelf of claim 11, wherein the third piece includes non-dove tail track protrusions on its bottom to enable it to sit into dove tail track openings of a top of the first piece.

13. The shelf of claim 8, wherein opposing surfaces of the first and second pieces include grooves and ridges, wherein grooves of the first piece are configured to snap into ridges of the second piece and grooves of the second piece are configured to snap into ridges of the first piece to enable the width of the U-shaped member to be adjusted to the width of the cabinet prior to installation therein.

14. The shelf of claim 13, wherein the first and second L-shaped pieces are identical.

15. The shelf of claim 13, wherein the first and second L-shaped pieces may be cut or broken to the width of the cabinet.

16. The shelf of claim 1, wherein the U-shaped member is manufactured by injection molded plastic manufacturing procedures.

17. A method for manufacturing a shelf, the method comprising:
constructing a U-shaped member configured to be installed in a cabinet having a back wall and opposing side walls;
wherein the width of the U-shaped member is the width of the back wall of the cabinet.

18. The method of claim 17, wherein said constructing the U-shaped member comprises:
constructing the U-shaped member as a single member constructed to a predetermined cabinet width.

19. The method of claim 17, wherein said constructing the U-shaped member comprises:
constructing first and second L-shaped pieces, configured to connect to one another to enable the width of the U-shaped member to be adjusted to the width of the cabinet prior to installation therein.

20. The method of claim 17, wherein said constructing the U-shaped member comprises:
constructing the U-shaped member by an injection molded plastic manufacturing process.
